(19) United States
(12) Patent Application Publication
(10) Pub. No.: US 2013/0008115 A1
(43) Pub. Date: Jan. 10, 2013

(54) Building construction sheathing composites, structures and related methods of use

(76) Inventor: Timm Bierman, Sussex, WI (US)

(21) Appl. No.: 12/005,876

(22) Filed: Dec. 28, 2007

(51) Int. Cl. B32B 3/02; E04B 2/88; E04B 1/64; B32B 3/10

(52) U.S. Cl. 52/420; 428/81; 428/138; 52/741.4

(57) ABSTRACT

Sheathing composites can be employed in a building structure with framing members. Such a composite can comprise a substrate and a layer component, the latter comprising at least one flashing component with a directional indicator thereon.

### BACKGROUND OF THE INVENTION

Sheathing generally comprises sheets of plywood, oriented strand board (OSB), extruded foam board or gypsum board or the like which are nailed or otherwise fastened to structural members defining a building frame. Weather/water resistant barriers are typically placed on or secured to the sheathing to prevent the infiltration of water and/or air (drafts) into the building. A barrier material with vapor permeability can also promote passage of moisture therefrom.

Installation of weather resistant barriers to wall or roofing structures can be labor intensive. Exposure to the elements, especially strong winds, before cladding construction often necessitates replacement of entire wall sections, at great cost to the builder in terms of both time and materials Flashing of penetrations (e.g., windows, doors, etc) in a wall or roof and flashing of the joints between sheets of weather resistant barrier can be confusing, difficult and is often done improperly. Faulty installation can cause damage to and degradation of underlying structural members, eventually resulting in costly rehabilitation (e.g., wall, window, etc. replacement) well short of expected building lifetime.

Responsive to such issues, several material systems have been developed. Representative of such efforts is a wall sheathing panel with a water-resistive barrier constructed directly on an underlying support material. Such a composite allows one-step installation of both materials over a building frame. However, a flashing tape is needed to cover seams between adjacent panels. For obvious reasons, such an approach is problematic for vertical panel seams. Regardless, each piece of tape, in turn, creates two more seams for potential water penetration. Accordingly, there remains an on-going search in the art for a sheathing composite and configuration better able to utilize the benefits and advantages associated with available weather resistant barrier materials.

### SUMMARY OF THE INVENTION

In light of the foregoing, it is an object of the present invention to provide a weather/water-resistant sheathing and/or method(s) for use in the building or construction trades, thereby overcoming various deficiencies and shortcomings of the prior art, including those outlined above. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It can be an object of the invention to provide an improved material system for use as wall sheathing which has a weather resistant layer component with an extended flashing to avoid cumbersome taping procedures of the prior art and improve weather resistance.

It can be another object of the invention to improve the overall quality of buildings by minimizing water and air infiltration into the structure.

It can be another object of the invention to minimize the common occurrence of weather resistant barriers disconnected from the structure and damaged prior to the completion of exterior wall and roof claddings.

It can be another object of the invention to provide a sheathing or component thereof promoting increased breathability and ventilation of underlying structural cavities.

It can be another object of this invention, alone or in conjunction with one or more of the preceding objectives, to provide a method of using the present sheathing composites to promote proper installation and provide for quick, visual confirmation before completion of exterior wall and/or roofing claddings.

Other objects, features, benefits and advantages of the present invention will be apparent from this summary and the following descriptions of certain embodiments, and will be readily apparent to those skilled in the art having knowledge of various building construction materials and techniques. Such objects, features, benefits and advantages will be apparent from the above as taken into conjunction with the accompanying examples, figures, and all reasonable inferences to be drawn therefrom.

In part, the present invention can be directed to a sheathing composite, as can be used in the building trades. Such a sheathing composite can comprise a substrate component and a layer component on or coupled to the substrate component and comprising at least one peripheral edge extending therebeyond. Such a peripheral edge can comprise a flashing component of the sheathing composite, and the flashing component can comprise at least one directional indicator thereon.

In certain non-limiting embodiments, the composite can comprise a parallelogram, rectangular or square configuration, with a layer component comprising one or more peripheral edges. In certain such embodiments, such a composite can comprise a plurality of flashing components extending beyond the substrate component. Regardless of composite configuration, as illustrated below, one or more flashing components can comprise a plurality of directional indicators thereon and/or can comprise, on an upper or lower surface thereof, a sealingly engageable member, such a member including but not limited to a self-adhesive material.

As would be understood by those skilled in the art and/or familiar with the building trades, such a substrate component can comprise but is not limited to an orient strand board, a particle board, a chip board, a gypsum board, a foam board, or can be constructed from hardboard or plywood or can comprise combinations thereof. Regardless of substrate component(s) composition or construction, a layer component can comprise a material comprising a vapor permeable component and/or a water resistant component. Such materials are also well known to those skilled in the art and/or a layer component can be treated to provide such permeability and/or resistance properties. Without limitation, one or more such layer components can be on, coupled to, or connected with such a substrate component. In certain such embodiments, a layer component can be mechanically coupled to such a substrate component. In certain other embodiments, such a layer component can be bonded to a substrate component, such bonding as can be achieved using an adhesive material compatible (e.g., vapor permeable, water resistant, etc.) with the layer component. Regardless of layer component coupling, such a substrate component can comprise one or more apertures or pores through first and second sides thereof.

In part, the present invention can also be directed to a rectangular sheathing composite comprising a substrate component comprising first and second opposed sides and at least one pore or aperture therethrough; and a layer component coupled to such a substrate component, such a layer component comprising peripheral edges extending beyond the substrate component, with each peripheral edge comprising a flashing component of the composite and each flashing component comprising at least one directional indicator thereon. Such layer and flashing components can be constructed and/or configured as otherwise described herein. Regardless, such a substrate component can be selected from, but is not limited to, orient strand board, particle board, chip board, hardboard, gypsum board, foam board, plywood and of other materials known to those skilled in the art made aware of this invention. Likewise, as illustrated herein, sheathing composite(s) of this invention can be coupled to a building structure framing member, such members including but not limited to one or more wall studs, roofing rafters and combinations thereof.

In part, this invention can also be directed to a building structure. Such a structure can comprise a plurality of framing members; a plurality of adjacent, peripherally coupled sheathing composites coupled to the framing members, each such composite comprising a substrate component of the sort described above; and a layer component coupled to the substrate component, such a layer component as can comprise multiple peripheral edges extending beyond the substrate and as can comprise flashing components of the composite. Each such flashing component can comprise at least one directional indicator thereon and, in the context of such a structure, the flashing component of one sheathing composite can overlap the layer component of another sheathing composite adjacent thereto. Framing members of such a structure can be selected from those understood in the art and associated building trades. In certain embodiments, without limitation, framing members can be selected from a plurality of wall studs, roofing rafters, window frames/jambs and/or door frames/jambs.

In certain such structural embodiments, regardless of sheathing composite configuration or material construction, each such flashing component can comprise a member sealingly engageable with the layer component of an adjacent sheathing composite and/or, as illustrated below, can comprise a plurality of directional indicators. In certain such embodiments, such an engageable member can comprise an adhesive strip, as can be positioned on a flashing underside for sealing engagement with overlap of an adjacent sheathing layer component. Such engagement can be effective in conjunction with a layer component comprising a vapor permeable and/or a water resistant material, non-limiting representative examples of which are discussed elsewhere herein.

In the context of a building structure, the present invention can also be directed to a method of using a sheathing composite of this invention to indicate and/or visually affirm an overlapping relationship of one such composite to another. Such a method can comprise providing a first sheathing composite comprising a substrate component, and a layer component coupled thereto and comprising multiple peripheral edges, at least one of which extends beyond the substrate and comprises a flashing component of the composite, such a flashing component comprising at least one directional indicator; coupling such a first sheathing composite to a building structure; and coupling a second sheathing composite to the building structure, with at least a portion of one second composite flashing component, with a directional indicator thereon, overlapping the layer component of the first sheathing composite.

In certain embodiments, illustrative of one or more benefits associated with this invention, such a second composite can be positioned upwardly from or in relation to a first sheathing composite, such that a bottom peripheral edge thereof can comprise a flashing component overlapping at least a portion of a first sheathing layer component. In certain such embodiments, the bottom flashing component can comprise a plurality of downward directional indicators, to readily evidence flashing overlap and water protection, upon visual inspection. Without limitation, such a methodology can, as described elsewhere herein, sealingly engage such a flashing component with an adjacent composite layer component, to further enhance or promote water protection.

As illustrated in one or more of the accompanying figures, a plurality of additional sheathing composites can be upwardly and/or laterally positioned with respect to the aforementioned first and/or second sheathing composites. Each additional sheathing composite can comprise a side and a bottom flashing component overlapping the layer component(s) of a composite positioned laterally or therebelow. Each such flashing component(s) can comprise one or more downward and/or horizontal directional indicators—affirming overlap, promoting water protection in conjunction with an adjacent layer component and/or visibly indicating a degree or condition of positive drainage of water away from a structure interior. Such positive drainage indication can be in or confirm compliance with a building or construction code, whether existing now or enacted later.

As also illustrated herein, such a building structure can provide one or more framing members of the sort discussed elsewhere herein. Without limitation, a plurality of wall studs can define a wall opening (e.g., door, window, etc.), and at least one of the first, second and/or additional sheathing composite flashing components and directional indicator(s) thereon can overlap such a defined opening, as discussed below, to promote and visually affirm an overlap relationship.

### BRIEF DESCRIPTION OF THE DRAWINGS

FIG. 1 is a side elevation through section of a sheathing composite, in accordance with this invention.

FIG. 2 is a plan view of a non-limiting sheathing composite, in accordance with this invention.

FIG. 3A is a side elevation through section an inventive composite, schematically shown as supported by framing members.

FIG. 3B is a partial bottom view of a flashing component of a composite of FIG. 3A, showing optional adhesive tape and removable strip components.

FIG. 4 is a plan view of a building structure, in accordance with this invention, showing a plurality of panels and directionally indicating installation, including the flashing of wall penetrations.

### DETAILED DESCRIPTION OF CERTAIN EMBODIMENTS

Representative of various non-limiting embodiments, this invention can comprise a weather resistant layer component laminated on a commonly-used wall sheathing material substrate component, with an extended layer component providing a flashing over or between adjacent composite sheath. Such sheathing composites are secured to structure framing members, with the weather resistant layer component facing outward. Once installed, such composites provide weather protection to exterior wall (or roof) structures, contribute to improve performance and provide for attachment of exterior claddings (e.g., clapboard, vinyl, siding, etc.) thereafter.

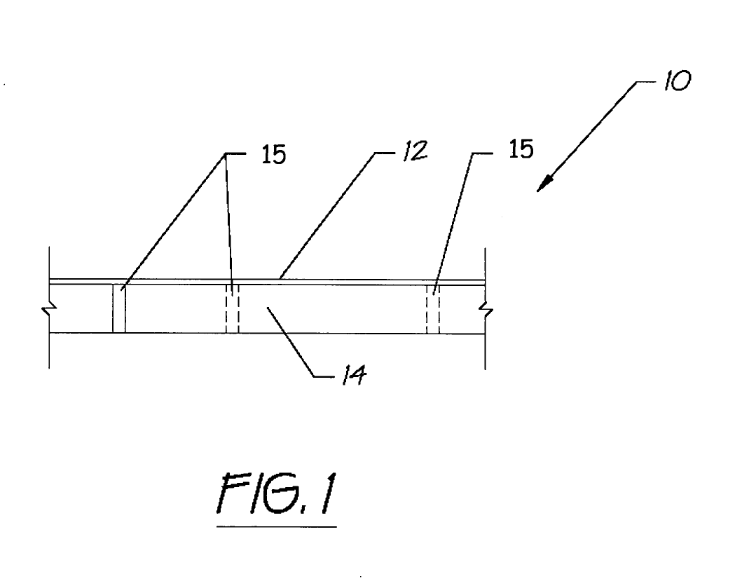

With reference to the partial sectional view of FIG. 1 (not to scale), composite sheet 10 is shown with weather resistant layer component 12 bonded and/or coupled to substrate component 14. Such a substrate may be of plywood, OSB, foam board, gypsum board or other material otherwise described herein or known to those skilled in the art. Regardless of material construction, such a substrate can address or facilitate movement of water vapor in/out of the framing structure using a series of spaced and/or periodic pores or apertures 15. Such perforations can be made by drilling, punching or boring through the substrate prior to lamination with layer component 12. With regard to the later, such a layer component can be water tight and vapor permeable for both weather resistance and to facilitate vapor movement in/out of the framing structure. Such layer components can comprise a material construction as would be understood by those skilled in the art made aware of this invention Without limitation, such layer components can be or include commercially-available TYVEK® products or other such so-called “housewrap” materials including the BLUESKIN BREATHER vapor permeable self-adhesive weather barrier available from the Henry Company. Regardless, such a component can be bonded to substrate 14 with a vapor permeable adhesive such as the Zinsser V. P. Wall Covering Adhesive System or a vapor permeable spray adhesive available from Hollister, Inc.

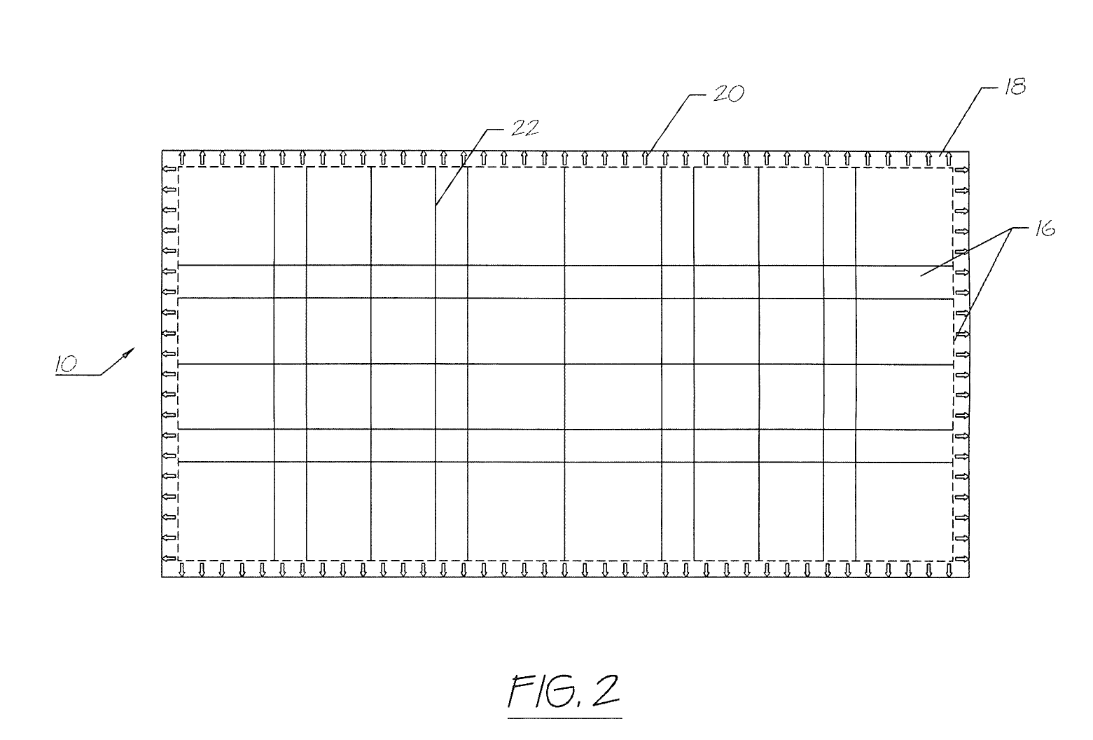

Regardless of material construction, FIG. 2 shows composite 10 in plan view. Peripheral edge 16 of layer component 12 provides flashing component 18 extending beyond substrate 14. Directional indicators 20 and alignment markers 22 ensure proper composite installation, as discussed more fully below.

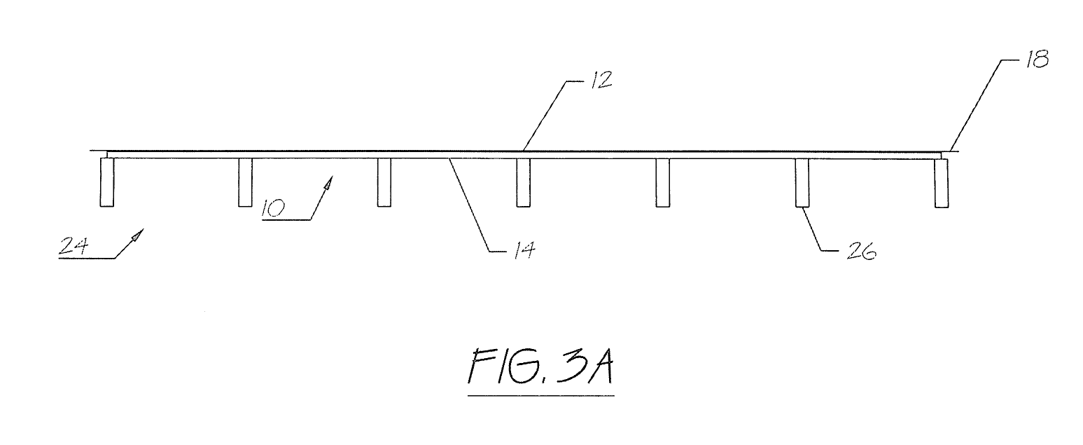

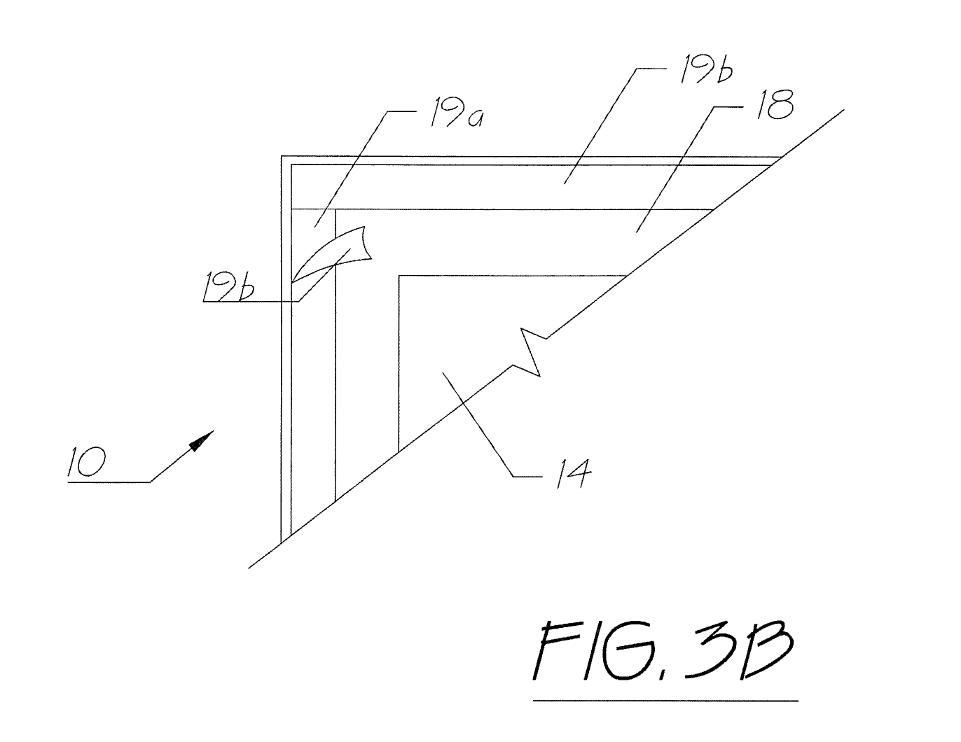

Certain embodiments are illustrated by the side elevation view of FIG. 3A. Building structure 24 is provided with composite 10 on or engaging framing members 26. As shown, flashing component 18 extends beyond a peripheral framing member 26, for optional sealing engagement therewith. More generally, flashing component 18 can be configured to include a pressure sensitive adhesive or adhesive tape 19a, optionally with a removable strip 19b and/or on the underside thereof, for folded engagement with a framing member or overlap of an adjacent composite sheet. (FIG. 3B) Either arrangement can be used, in conjunction with layer component 12, to provide a sealed air barrier on a building structure and prevent layer component separation from substrate 14, a problem common in the prior art.

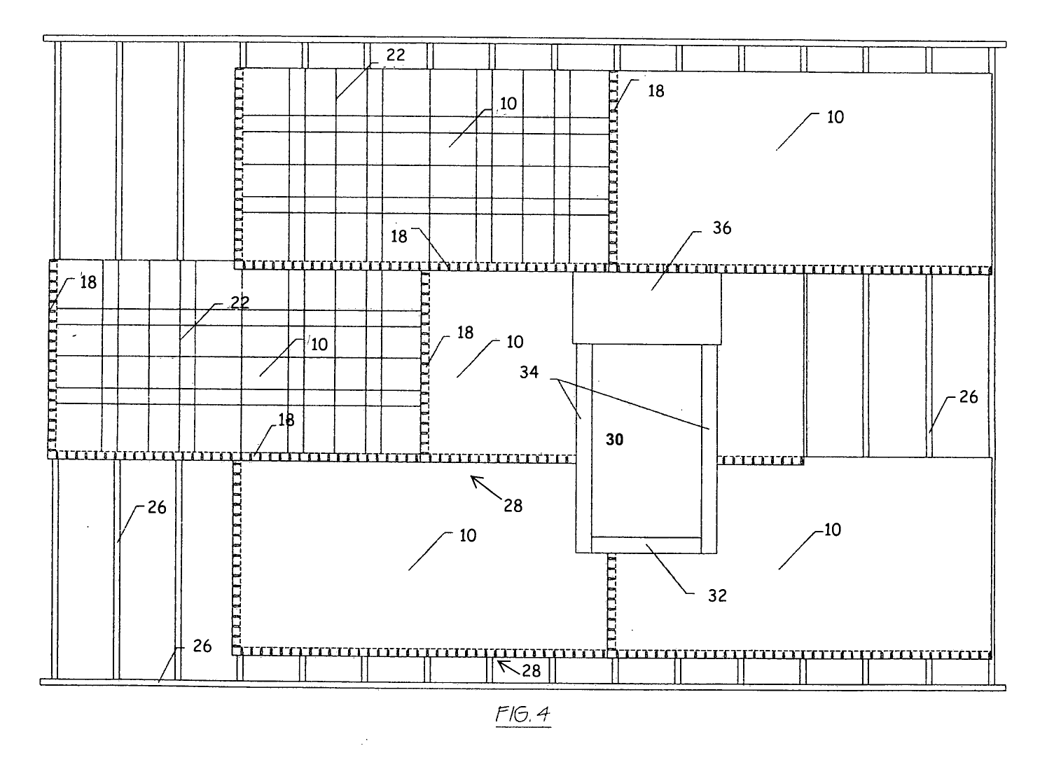

As discussed above, directional indicators 20 on one or more flashing components 18 promote proper installation and can facilitate visual inspection with respect to code compliance and the like. FIG. 4 shows a plurality of composites 10 installed over structural framing members 26 using alignment markers 22. Successive sheets can be installed, in what would be known as “shingle-style”, with the leading edges (e.g., top and either left or right) folded over the edge of the underlying substrate component or framing member, as shown at 28. Such bottom-up and lateral (i.e., left to right or right to left) installation provides a plurality of installed composite sheets 10 with all horizontal directional indicators 20 pointed either left or right and vertical directional indicators 20 pointed downward.

With further reference to FIG. 4, building structure 24 can define an opening 30 for windows, doors, mechanical installations and the like. Accordingly, the present invention can include use of partial composite sheets 10 and/or layer components 12 with the corresponding framing members. For instance, a sill flashing component 32, configured from a portion of a layer component 10, can be overlapped by jamb flashing 34, also constructed from a portion of a layer component 10. In turn, jamb flashing components 34 can be overlapped by a head flashing component 36, also prepared by a portion of a layer component 10. Likewise, head flashing component 36 can be tucked under and overlapped by flashing component 18 of composite sheet 10 positioned thereabove. In certain embodiments, flashing components 32, 34 and/or 36 can be provided in a variation of contrasting color schemes or markings to promote visual inspection and/or approval of the finished installation.

In the context of building construction, the methods of this invention can be implemented with sheathing composites dimensioned according to such practical considerations. For example, regardless of material construction, a 52″×100 ″ layer component can be bonded to a 48″×96″ substrate to provide a 2″ layer component peripheral edge and flashing component extending beyond the underlying substrate component. As mentioned above, in conjunction with FIGS. 2-4, such composites can include alignment markings for attachment to wall studs and/or roofing rafters. Such markings may be at 12″, 16″ and 19.2″ centers and/or color coded to distinguish each. Composite sheets can then be nailed or screwed into the framing member. As with directional indicators 20, such markings 22 can facilitate visual inspection by an architect, structural engineer, building inspector, contractor, owner, etc., for compliance with required structural fastening. Such markings can also provide guidelines for subsequent installation of exterior claddings or other wall finishes (e.g., masonry, wall tiles, expanded metal lathes for stucco or cultured stone finishes, etc.).

While the principles of this invention have been described in connection with specific embodiments, it should be understood clearly that these descriptions are added only by way of example and are not intended to limit, in any way, the scope of this invention. For instance, the present invention can be applied more specifically to the construction of a roof/deck structure, in a manner as described above—substituting rafters and related structural supports for wall studs and the like. Likewise, while this invention has been described above in conjunction with certain exterior building structures, it will be understood by those skilled in the art that the composites of this invention can be used in conjunction with various internal wall and/or ceiling structures, such use as can depend upon choice of a suitable substrate component. Alternatively, as can be used with various other embodiments, a sheathing composite of this invention can comprise layer components coupled to both first and second sides thereof, as may be employed and depending on a particular construction or end-use application. Other advantages and features will become apparent from the claims to be filed hereafter, with the scope of such claims determined by the reasonable equivalence, as would be understood by those skilled in the art.

1. A sheathing composite comprising a substrate component and a layer component coupled thereto, said layer component comprising a plurality of peripheral edges, each said peripheral edge extending beyond said substrate component, each said peripheral edge comprising a flashing component of said composite, one said flashing component comprising a first directional indicator thereon and another said flashing component comprising a second directional indicator thereon, said first directional indicator indicating a direction perpendicular to that of said second directional indicator.

2. The sheathing composite of claim 1 comprising a parallelogram configuration.

3. The sheathing composite of claim 2 wherein said each flashing component comprises a plurality of directional indicators.

4. The sheathing composite of claim 1 wherein each said flashing component comprises a sealingly engageable member.

5. The sheathing composite of claim 1 wherein said substrate component is selected from orient strand board, particle board, chip board, hardboard, gypsum board, foam board, and plywood.

6. The sheathing composite of claim 5 wherein said layer component comprises a material comprising at least one of a vapor permeable component, a water resistant component and combinations thereof.

7. The sheathing composite of claim 6 wherein said layer component is coupled to said substrate component with a vapor permeable adhesive.

8. The sheathing composite of claim 1 coupled to a building structure framing member.

9. The sheathing composite of claim 1 wherein said substrate component comprises first and second opposed sides and at least one aperture therethrough.

10. A rectangular sheathing composite comprising a substrate component comprising first and second opposed sides and at least one aperture therethrough, said aperture for movement of water vapor through said substrate, said aperture not through a periphery of said substrate component; and a layer component coupled to said substrate component, said layer component comprising peripheral edges, each said peripheral edge extending beyond said substrate component, each said peripheral edge comprising a flashing component of said sheathing composite, each said flashing component comprising at least one directional indicator thereon.

11. The sheathing composite of claim 10 wherein said substrate component is selected from orient strand board, particle board, chip board, hardboard, gypsum board, foam board, and plywood.

12. The sheathing composite of claim 10 coupled to a building structure framing member selected from a plurality of wall studs, a plurality of roofing rafters and combinations thereof.

13. A building structure comprising a plurality of framing members and a plurality of installed, adjacent, peripherally-coupled sheathing composites coupled thereto, each said sheathing composite comprising a substrate component and a layer component coupled thereto, said layer component comprising multiple peripheral edges, each said peripheral edge extending beyond said substrate and comprising a flashing component of said composite, a said flashing component of said installed sheathing composite comprising at least one visible directional indicator thereon, a said flashing component of one said installed sheathing composite overlapping the layer component of another said installed sheathing composite adjacent thereto.

14. The building structure of claim 13 wherein each said flashing component of each said sheathing composite comprises a member sealingly engageable with said layer component of said adjacent sheathing composite.

15. The building structure of claim 14 wherein said engageable member comprises an adhesive strip.

16. The building structure of claim 13 wherein each said flashing component comprises a plurality of directional indicators.

17. The building structure of claim 13 wherein said substrate component is selected from orient strand board, particle board, chip board, hardboard, gypsum board, foam board, and plywood.

18. The building structure of claim 13 wherein said layer component is coupled to said substrate component with a vapor permeable adhesive.

19. The building structure of claim 13 wherein said framing members are selected from a plurality of wall studs, a plurality of roofing rafters and combinations thereof.

20-25. (canceled)
